(19) United States
(12) Patent Application Publication
(10) Pub. No.: US 2009/0016401 A1
(43) Pub. Date: Jan. 15, 2009

(54) COMBUSTION STATE DETERMINING APPARATUS AND METHOD FOR CATALYTIC COMBUSTION UNIT

(75) Inventors: Karuki Hamada, Kanagawa (JP); Nobuo Sakiyama, Kanagawa (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi, Kanagawa (JP)

(21) Appl. No.: 12/278,056

(22) PCT Filed: Feb. 7, 2007
(86) PCT No.: PCT/IB07/00303

§ 371 Date: Aug. 1, 2008

(30) Foreign Application Priority Data
Feb. 7, 2006 (JP) 2006-029538

(51) Int. Cl. G01N 25/22; F23C 13/00

(52) U.S. Cl. 374/10; 431/326

(57) ABSTRACT

An apparatus and method for determining a combustion state includes a catalytic combustion unit for mixing an anode off-gas discharged from a fuel pole of a fuel cell and an oxidizing agent gas, and having a catalytic unit for performing combustion processing. An upstream temperature detecting unit detects a gas temperature at an upstream side of the catalytic unit, and a gas-phase combustion determining unit compares at least one of the gas temperature detected by the upstream temperature detecting unit and a rate of upstream temperature increase with a determining reference value to determine if gas-phase combustion occurs at the upstream side of the catalytic unit.

### CROSS-REFERENCE TO RELATED APPLICATION

This application claims priority from Japanese Patent Application Serial No. 2006-029538, filed Feb. 7, 2006, which is incorporated herein in its entirety by reference.

### TECHNICAL FIELD

The present invention relates in general to a combustion state determining apparatus and method for a catalytic combustion unit.

### BACKGROUND

Generally, in order to prevent a reduction in electricity generation efficiency or a halt in electricity generation in a fuel cell system due to increases in the concentrations of nitrogen and water vapor at an anode side, a purge process is performed in which gas and condensed water of the anode side are outwardly discharged from the system. Since unused portions of hydrogen fuel (together with nitrogen or water vapor) are contained in the gas, which is outwardly discharged from the system by the purge process (and is hereinafter referred to as anode off-gas), it is necessary to perform an additional process in which another gas is mixed with the anode off-gas such that the hydrogen concentration is diluted or in which an oxidizing agent is mixed into the anode off-gas to thereby combust the hydrogen.

However, when a catalytic combustion unit is used to combust the hydrogen, a back fire is generated with the rise in combustion temperature such that the catalytic combustion unit changes to a gas-phase combustion state from a normal catalytic combustion state. Herein, the gas-phase combustion refers to a reaction between hydrogen and an oxidizing agent, which occurs due to a combustion accompanying a back fire in a gaseous state rather than through a catalyst. If the combustion state converts to the gas-phase combustion state, then thermal damages to the catalytic combustion unit, catalyst and surrounding environment may occur due to the rising combustion temperature. Alternatively, the environment may be significantly affected by the generation of a secondary gas such as NOx, which results from the high temperature gas-phase combustion. Japanese Laid-Open Patent Publication No. 11-118115 discloses an apparatus in which a unit for detecting temperature is provided proximate to an upstream side of a fuel supply unit of a catalytic combustion unit, wherein gas-phase combustion due to a back fire from a catalyst is determined based on the temperature detected by the temperature-detecting unit. In addition, Japanese Laid-Open Patent Publication No. 2004-37034 discloses an apparatus in which a flame sensor is disposed proximate to a fuel supply unit of a catalytic combustion unit, wherein a back fire from a catalyst is detected by the flame sensor.

### BRIEF SUMMARY

Embodiments of an apparatus for determining a combustion state of a catalytic combustion unit are taught herein. One example of such an apparatus comprises a fuel cell and a catalytic combustion unit including a catalytic unit. The catalytic combustion unit is configured to mix an anode off-gas discharged from a fuel pole of the fuel cell and an oxidizing agent gas different from a cathode off-gas discharged from an oxidizing agent pole of the fuel cell and is configured to perform combustion processing in the catalytic unit. The apparatus in this example also includes an upstream temperature detecting unit for detecting a gas temperature at an upstream side of the catalytic unit and a controller configured to compare at least one of the gas temperature at the upstream side of the catalytic unit and a rate of upstream temperature increase with a reference value to determine if gas-phase combustion occurs at the upstream side of the catalytic unit.

Methods for determining a combustion state of a catalytic combustion unit including a catalytic unit are also taught herein. In one example where a fuel cell is positioned upstream from the catalytic combustion unit, the method comprises mixing in the catalytic combustion unit an anode off-gas discharged from a fuel pole of the fuel cell and an oxidizing agent gas different from a cathode off-gas discharged from an oxidizing agent pole of the fuel cell, performing a combustion process in the catalytic unit, detecting a gas temperature at an upstream side of the catalytic unit and comparing at least one of the gas temperature at the upstream side of the catalytic unit and a rate of upstream temperature increase with a reference value for determining if gas phase combustion occurs at the upstream side of the catalytic unit.

### BRIEF DESCRIPTION OF THE DRAWINGS

The description herein makes reference to the accompanying drawings wherein like reference numerals refer to like parts throughout the several views, and wherein:

FIG. 1 is a block diagram of a fuel cell system according to an embodiment;

FIG. 2 is a block diagram of a modified example of the fuel cell system of FIG. 1;

FIG. 3 is a block diagram of another modified example of the fuel cell system of FIG. 1;

FIG. 4 is a block diagram of yet another modified example of the fuel cell system of FIG. 1;

FIG. 5 is a schematic view of a modified example of a combustion unit of FIG. 1;

FIG. 6 is a schematic view of an internal structure of an exhaust pipe arrangement shown in FIG. 1;

FIG. 7 is a schematic view of a modified example of an internal structure of the exhaust pipe arrangement of FIG. 6;

FIGS. 8a and 8b are graphs illustrating a gas temperature variation at upstream and downstream sides of a catalytic unit during a combustion startup in accordance with a time variation;

FIGS. 9a and 9b are graphs illustrating a gas temperature variation at upstream and downstream sides of a catalytic unit during a continuous purge in accordance with a time variation;

FIGS. 10a and 10b are graphs illustrating a gas temperature variation at upstream and downstream sides of a catalytic unit during an intermittent combustion startup in accordance with a time variation;

FIG. 11 is a chart illustrating a relation between a gas temperature and a rate of temperature increase at an upstream side of the catalytic unit and a gas temperature and a rate of temperature increase at a downstream side of the catalytic unit during a typical combustion and during a gas-phase combustion at an upstream side of the catalytic unit;

FIG. 12 is a flowchart illustrating a combustion state determining process according to a first embodiment;

FIGS. 13a to 13c are diagrams illustrating determining references according to one embodiment;

FIG. 14 is a flowchart illustrating a combustion state determining process according to a second embodiment;

FIG. 15 is a flowchart illustrating a combustion state determining process according to a third embodiment;

FIG. 16 is a flowchart illustrating a modified example of the combustion state determining process of FIG. 15;

FIG. 17 is a flowchart illustrating a modified example of the combustion state determining process of FIG. 12;

FIG. 18 is a flowchart illustrating a modified example of the combustion state determining process of FIG. 14;

FIG. 19 is a flowchart illustrating another modified example of the combustion state determining process of FIG. 14;

FIG. 20 is a flowchart illustrating yet another modified example of the combustion state determining process of FIG. 14;

FIG. 21 is a flowchart illustrating still yet another modified example of the combustion state determining process of FIG. 14;

FIG. 22 is a flowchart illustrating a combustion state determining process according to another embodiment; and

FIG. 23 is a flowchart illustrating a combustion state determining process according to still yet another embodiment.

### DETAILED DESCRIPTION

In known catalytic combustion units, when the oxidizing agent gas supplied to the unit contains a large amount of water or the oxygen concentration in the oxidizing agent gas is low, the ignition performance of the catalyst becomes damaged. Water has a significant influence. Thus, when water covers the catalyst, it is not possible to ensure a reaction area such that it becomes impossible to attain the original ignition performance. Further, if there is a reduction in the ignition performance of the catalyst, then problems are encountered with respect to the exhaust characteristics of the fuel cell system. Additionally, if it is not possible to achieve precise ignition then control of the catalytic combustion unit becomes impeded such that the efficiency of the fuel cell system is adversely affected.

Further, even if the temperature at a downstream side of the catalytic combustion unit is detected it is not possible to quickly determine a gas-phase combustion state at an upstream side of the catalytic unit due to a back fire. Also, when determining a gas-phase combustion state at the upstream side of the catalytic unit using a temperature-detecting unit, in a case where the catalytic unit and the temperature-detecting unit are separated by some distance, a gas-phase combustion state may be determined only if the back fire is generated over a considerable distance. As a result, whenever a gas-phase combustion state is determined, the combustion temperature rises by some amount, and the resulting heat causes a reduction in the catalytic performance. In particular, burning is accelerated if the catalyst is exposed to a temperature that exceeds a predetermined heat resistant temperature thereof, thereby resulting in a decrease in the service life of the catalytic combustion unit.

In addition, when the catalytic combustion unit is installed in a fuel cell vehicle, since restricted substances such as NOx are generated by the gas-phase combustion, it is necessary to quickly determine a gas-phase combustion state. However, even when using a temperature-detecting unit having a sufficient level of reliability or service life for use in a vehicle, its temperature reaction is slow so that a relatively significant time is required for temperature detection. Although a flame sensor may be used to determine a gas-phase combustion state, flame detection is delayed due to the influence of water when used in a fuel cell.

In contrast, embodiments of the combustion state determining apparatus and method for a catalytic combustion unit disclosed herein are capable of precisely and quickly determining a gas-phase combustion state of an upstream side of a catalytic unit.

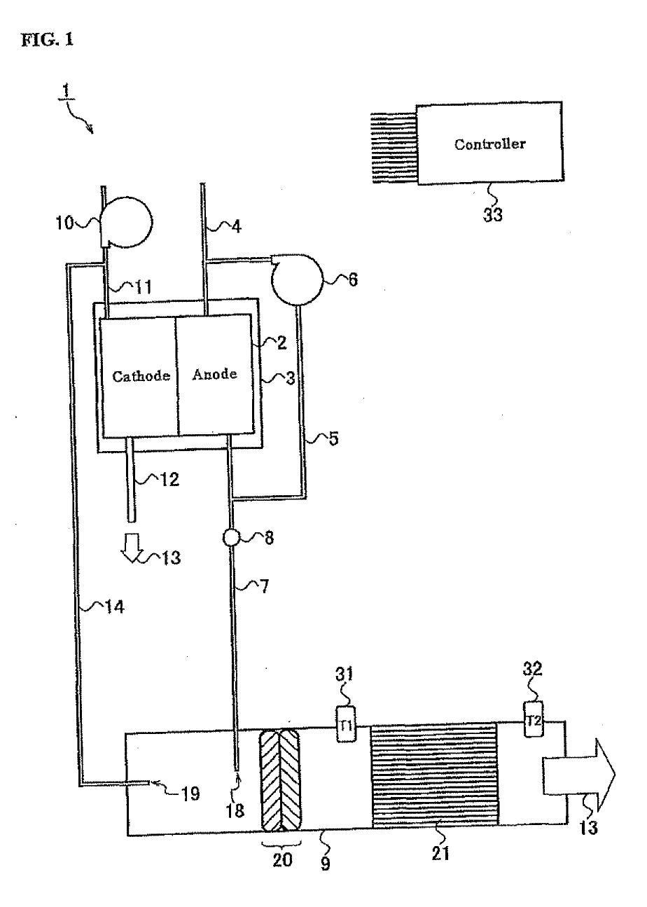

A fuel cell system of FIG. 1 may be applied to the invention disclosed herein. Referring to FIG. 1, a fuel cell system 1 according to an embodiment includes a fuel cell stack 3 configured to stack a plurality of fuel cells 2 that generate electricity by receiving hydrogen and air at an anode (fuel pole) and a cathode (oxidizing agent pole), respectively. Electrochemical reactions with respect to the anode and the cathode, as well as with respect to the entire fuel cell stack 3, occur as shown in equations (1) to (3). In this example, although hydrogen is supplied to the anode, it is possible to also supply thereto a modified gas containing sufficient hydrogen.

[Anode] H₂→2H⁺+2e⁻ (1)

[Cathode] 1/2O₂+2H⁺+2e⁻→H₂O (2)

[Entire stack] H₂+1/2O₂→H₂O (3)

The fuel cell system 1 includes a hydrogen tank and a hydrogen supply valve (both not shown). The hydrogen supply valve reduces the pressure of hydrogen in the hydrogen tank to a level matching a drive state of the fuel cells 2 and then supplies the hydrogen to the anode via a hydrogen supply pipe 4. Unused hydrogen at the anode is circulated to an upper side of the anode through a hydrogen circulation pipe 5 and a hydrogen circulation pump 6. By providing the hydrogen circulation pipe 5 and the hydrogen circulation pump 6, it is possible to reuse unused hydrogen at the anode to thereby enhance the fuel efficiency of the fuel cell system 1. Further, if a drive condition of the fuel cells 2 permits, the hydrogen circulation pump 6 may be used as a fluid pump injector. Aside from the hydrogen stored in the hydrogen tank, fluid hydrogen, hydrogen obtained from metal hydride or hydrogen obtained by modifying fuel gas may be supplied to the anode.

Liquid substances of liquefied excess water, impure gas such as water vapor or nitrogen in air leaked from the cathode may accumulate on the circulation paths of the hydrogen returned to the anode through the hydrogen circulation pipe 5 and the hydrogen circulation pump 6. This impure gas lowers the partial pressure of hydrogen to thereby reduce electricity generation efficiency, or increases the average molecular weight of the circulation gas to thereby make circulation difficult (deteriorates circulation efficiency). In addition, the liquid substances may interfere with hydrogen circulation or stack electricity generation. Hence, an anode off-gas pipe 7 and an anode purge valve 8 for opening and closing the anode off-gas pipe 7 are disposed on an output side of the anode. Further, when impure gas or liquid substances are accumulated, the anode purge valve 8 is opened, and gas discharged from the anode purge valve 8 (hereinafter referred to as anode off-gas) is purged after undergoing combustion processing in a combustion unit 9 using air. As a result, hydrogen partial pressure or circulation performance in the hydrogen circulation pipe 5 is returned to a normal state. In addition, an anode off-gas amount or timing discharged to the combustion unit 9 from the anode purge valve 8 may be either continuously purged by an amount controlled according to drive conditions (continuous purge) or intermittently purged by an amount controlled according to drive conditions (intermittent purge), as needed.

The fuel cell system 1 further includes a compressor 10 and a humidifier (not shown). Air discharged from the compressor 10 is passed through an air supply pipe 11 after undergoing humidification in the humidifier for supply to the cathode. Air unused in the cathode is passed through a cathode off-gas pipe 12 for transmission to an exhaust pipe 13. A bypass pipe 14 is connected to the air supply pipe 11. Air prior to undergoing humidification by the humidifier may be passed through the bypass pipe 14 for direct supply to the combustion unit 9.

With this structure, since air of a low humidification level and a high oxygen partial pressure compared to the cathode off-gas may be supplied to the combustion unit 9, adverse effects due to high humidification and low oxygen concentration of the cathode off-gas may be prevented. Further, combustion problems (e.g., accidental ignition and ignition delay) can be prevented to thereby allow for more reliable combustion. That is, reliable catalytic combustion processing is performed by the combustion unit 9 to thereby maintain a high combustion efficiency of the combustion unit 9.

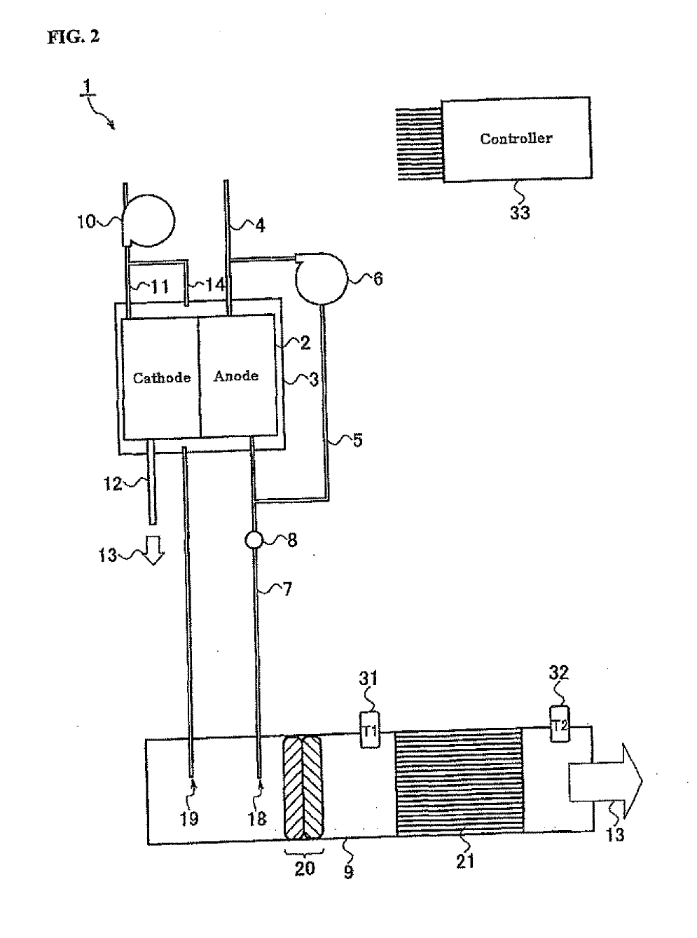

Further, with reference to FIG. 2, it may be possible for the air supplied by the bypass pipe 14 to enter a case surrounding the cell stack 3, after which the air passed through the case is supplied to the combustion unit 9. With this structure, air of a low humidification level and a high oxygen partial pressure compared to the cathode off-gas may be supplied to the combustion unit 9, such that a high combustion efficiency of the combustion unit 9 may be maintained. In addition, since hydrogen that is supplied to and dispersed in the case from the anode may be supplied to the combustion unit 9, the hydrogen may be reliably and effectively combusted. Further, since the air in the case is used for ventilation and for supply to the combustion unit 9, the system is simplified to thereby result in a reduction in size, weight and number of parts.

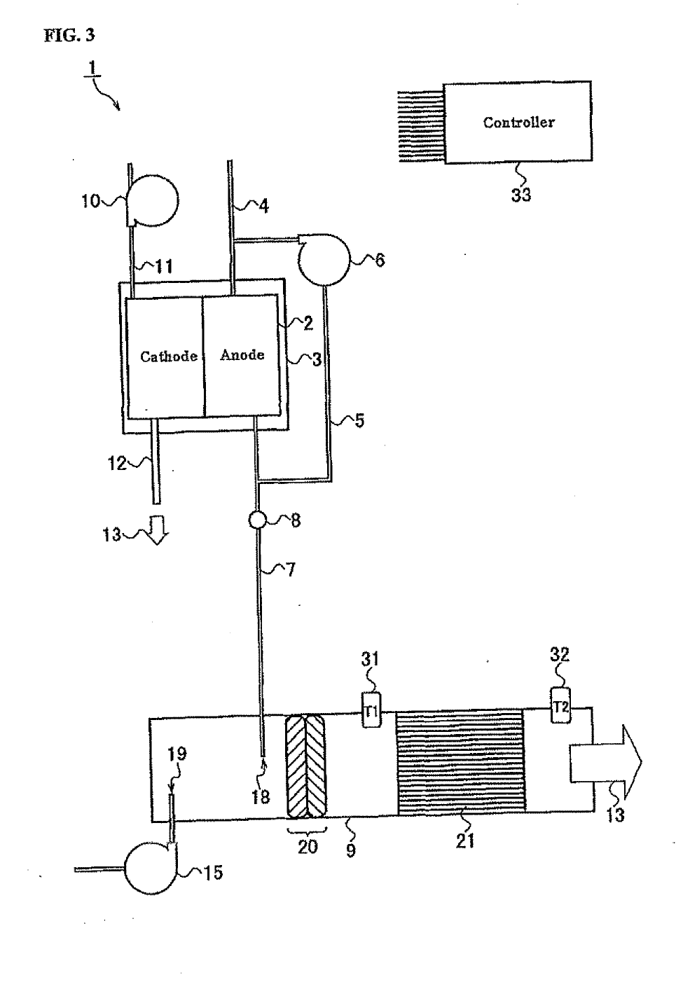

Referring now to FIG. 3, in addition to the compressor 10, an air supply apparatus 15 for the combustion unit 9 (e.g., a blower) may be provided to supply air to the combustion unit 9 for the combustion of the anode off-gas. With this structure, the air of a low humidification level and a high oxygen partial pressure compared to the cathode off-gas may be supplied to the combustion unit 9 such that a high combustion efficiency of the combustion unit 9 may be maintained. In addition, compared to the system in which only a single air supply apparatus is provided as in FIG. 1 or FIG. 2, by providing air supply apparatuses capable of supplying air amounts required by the fuel cells 2 and the combustion unit 9, it is possible to minimize the size of the air supply apparatuses, as well as achieving advantages in terms of weight, cost, power consumption, drive efficiency, control robustness, etc. Furthermore, by using two small air supply apparatuses at a low air flow side, it allows for more efficient driving than merely using a single large air supply apparatus. Also, when the air discharged from a single air supply apparatus is branched into two lines, control devices must be provided to control air flow in each of the lines. Hence, with the structure discussed above, it may be possible to prevent an increase in the number of parts.

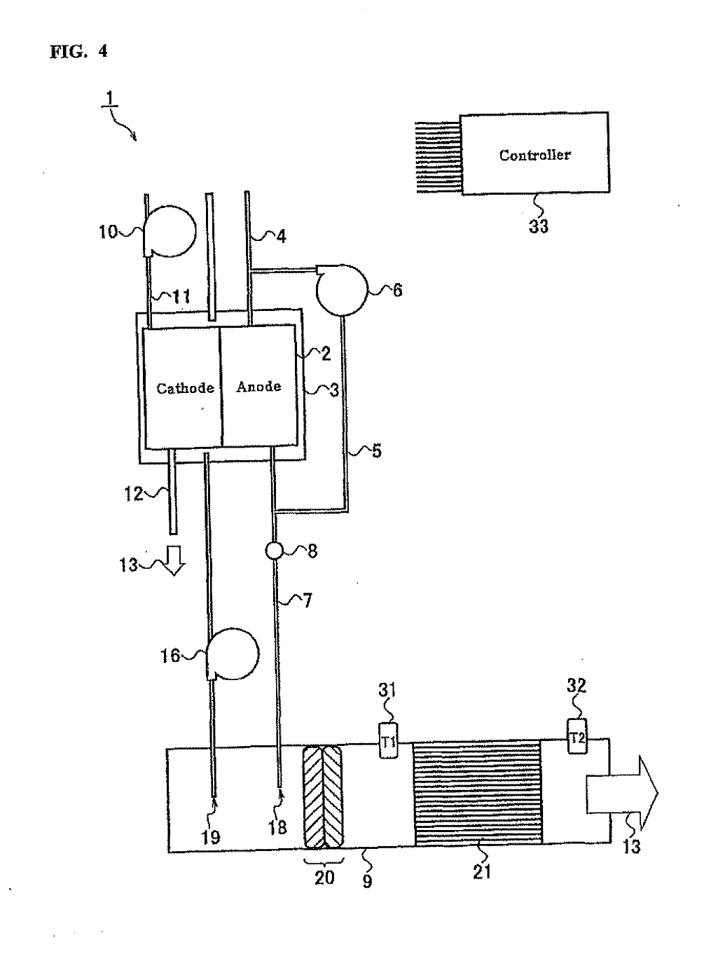

Referring now to FIG. 4, in addition to the compressor 10, an air supply apparatus 16 (e.g., a blower) may be provided to supply air passed through a case surrounding the cell stack 3 to the combustion unit 9. With this structure, since hydrogen that is supplied to and dispersed in the case from the anode in the fuel cell stack 3 may be supplied to the combustion unit 9, the hydrogen may be reliably and effectively combusted. Although the air supply apparatus 16 is disposed between the fuel cell stack 3 and the combustion unit 9, the air supply apparatus 16 may be disposed at an upstream side of the fuel cell stack 3. In sum, it may be possible to supply an oxidizing agent gas different from a cathode off-gas discharged from an oxidizing agent pole of the fuel cell to the combustion unit 9.

Referring to FIG. 1 through FIG. 4, the combustion unit 9 is made from a material that can withstand combustion temperatures and pressures such as a stainless steel alloy. The combustion unit 9 includes a cathode gas inlet 18 for supplying hydrogen from the anode off-gas pipe 7, an oxidizing agent gas inlet 19 for supplying air from the bypass pipe 14, a mixer 20 disposed at a downstream side of the cathode gas inlet 18, a catalytic unit 21 disposed at a downstream side of the mixer 20 and an exhaust pipe 13 disposed at a downstream side of the catalytic unit 21. With this structure, a back fire flame is prevented from reaching the cathode gas inlet 18. Alternatively, it is possible to prevent a dispersing flame at the anode inlet 18. As a result, excess mixture combustion occurs, which has a cleaner exhaust compared to dispersed flames. The formation or material of the combustion unit 9 may be varied as needed so long as requirements with respect to gas flow amount and heat emission amount are satisfied.

A front end of the cathode gas inlet 18 may be formed of a fuel injection pipe coupled to the anode off-gas pipe 7 and protrude into the combustion unit 9. Further, the anode off-gas can be discharged through a fuel injection hole formed at the front end thereof. More specifically, the front end of the cathode gas inlet 18 is formed of a ¼-inch stainless steel pipe, while a fuel injection hole is formed at a peripheral surface of the pipe.

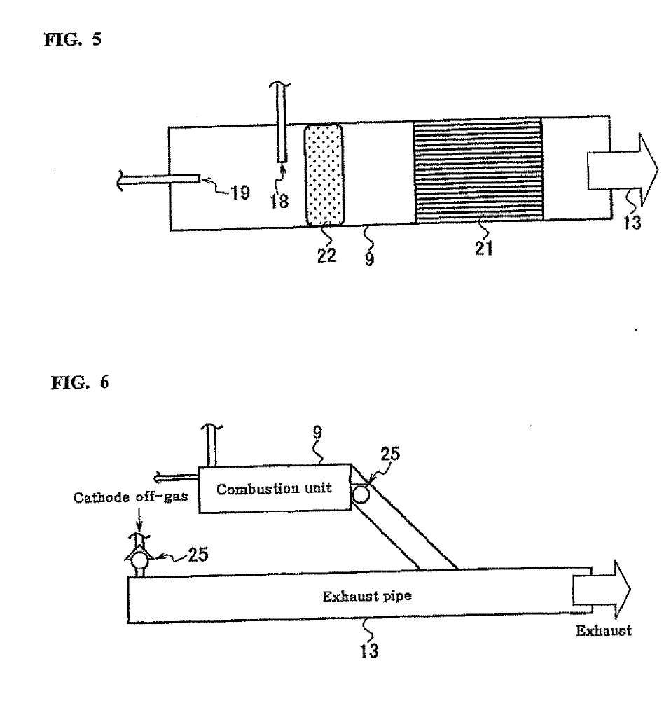

The mixer 20 is realized using a general gas mixing technology, such as a swirler and a plurality of perforated plates. It functions to mix the hydrogen and air supplied through the cathode gas inlet 18 and the oxidizing agent gas inlet 19. Referring to FIG. 5, a mixer 22 may be used, which has a flame arresting function. The flame arresting function may be realized by increasing the heat capacity of the mixer or through the use of perforated plates. Through the flame arresting function, the transmission of heat (combustion) energy to an upstream side of the mixer can be prevented.

The catalytic unit 21, shown in FIG. 1 through FIG. 5, is formed using a general catalysis technology in which a precious metal such as platinum is incorporated into a metal honeycomb or ceramic honeycomb carrier. A mixed gas formed by mixing hydrogen and air by the mixer 20 is combusted.

The exhaust pipe 13 is formed from a material that can withstand the heat of the gas discharged from the combustion unit 9. It functions to discharge the gas exhausted from the catalytic unit 21. A shape of the exhaust pipe 13 may be designed as needed, and a silencing device such as a muffler may be disposed on the exhaust pipe 13. Further, a heat exchanger or a turbine may be disposed at the downstream side of the catalytic unit 21 to enhance system efficiency.

Referring to FIG. 6, the exhaust pipe 13 includes a reverse flow preventing valve 25 (e.g., a check valve) disposed at a downstream side of the cathode off-gas pipe 12 and the combustion unit 9 to prevent reverse flow of the cathode off-gas and the combustion exhaust gas to the cathode off-gas pipe 12 and the combustion unit 9, respectively. Since exhaust pressure loss may be reduced with this structure, in addition to making the system more efficient, the air supply apparatus may be made smaller, lighter and less costly. Further, control may be simplified by preventing a reduction in control performance due to reverse flow of exhaust. In addition, by performing exhaust outwardly of the system after the cathode off-gas and the combustion exhaust gas are combined, the exhaust hydrogen concentration management and exhaust system may be simplified. Also, even if non-processed hydrogen is discharged as a result of some malfunctioning, the exhaust hydrogen concentration may be forced to a low concentration. Additionally, since an exhaust concentration measuring area is concentrated at one location, exhaust concentration testing is simplified.

The reverse flow preventing valves 25 need not be the same at the downstream side of the cathode off-gas pipe 12 and at the downstream side of the combustion unit 9. They may be varied as needed according to line and fluid characteristics of each. Further, a reverse flow preventing valve 25 may be disposed with respect to only one of the cathode off-gas pipe 12 and the combustion unit 9. Typically, in a check valve-type reverse flow preventing valve, a spring for closing the valve is compressed by a gas pressure from an upstream side, a cover for closing the valve is displaced by the spring being compressed, and the displacement of the cover opens the line such that gas may pass therethrough. On the other hand, when pressure is applied from a downstream side, the spring applies a biasing force to the cover in a direction to maintain a closed state of the same, thereby closing the line so that gas is prevented from passing therethrough. Accordingly, a respective reverse flow preventing valve 25 is opened to allow the flow of gas only when the pressure on a side of the reverse flow preventing valve 25 adjacent the cathode off-gas pipe 12 or the combustion unit 9 is greater than a pressure on a side thereof adjacent the exhaust pipe 13.

Referring now to FIG. 7, there may be disposed on the exhaust pipe 13 an exhaust gas inlet 26 for directing the exhaust gas discharged from the combustion unit 9 into the exhaust pipe 13. Further, a swirler 27 in turn is disposed on the exhaust gas inlet 26 and is formed of a disk-shaped plate that expands in a direction from an upstream side to a downstream side. With this structure, gas flow is detached from the downstream side of the swirler 27, and a large turbulent vortex is generated starting from the point of detachment. As a result of the gas flow by the turbulent vortex, cathode off-gas pressure (exhaust resistance) at the vicinity of the exhaust gas inlet 26 is reduced such that the combustion exhaust gas discharged from the combustion unit 9 may be effectively introduced into the exhaust pipe 13. Further, in addition to reducing the size, weight and cost of the air supply apparatus, the system is constructed to be more efficient. The exhaust gas inlet 26 may be formed of a pipe made from a material that can withstand combustion temperatures (e.g., stainless steel). In this case, a front end of the pipe may be formed with a plurality of holes, and the combustion exhaust gas may be supplied to the inside of the exhaust pipe 13 through the holes. Further, the swirler 27 may be formed of a fixed obstruction such as an interrupting plate or a variable butterfly valve so long as the required vortex can be generated. Additionally, instead of the swirler 27, it may be possible to decrease a cross section of the line so as to increase the gas flow speed, thereby reducing the pressure in the vicinity of the exhaust gas inlet 26.

As shown in FIG. 1 through FIG. 4, the fuel cell system 1 further includes an upstream temperature sensor 31 for detecting a gas temperature T1 at the upstream side of the catalytic unit 21, a downstream temperature sensor 32 for detecting a gas temperature T2 at the downstream side of the catalytic unit 21, and a controller 33 for controlling an overall operation of the fuel cell system 1.

The upstream temperature sensor 31 is disposed between the mixer 20 and the catalytic unit 21 to thereby detect the temperature at a location not easily affected by the heat capacity of the mixer 20. The upstream temperature sensor 31 assists in quickly making a determination of temperature variations when a back fire is generated. General temperature measuring devices (e.g., thermistors) may be used for the temperature sensors 31, 32 as long as the temperature sensors 31, 32 can withstand the conditions under which they are used. In this embodiment, the controller 33 may be a microcomputer having a CPU, a programmable ROM, an application RAM and an input/output interface.

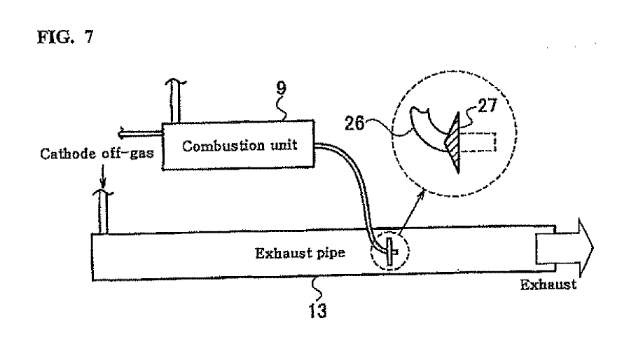

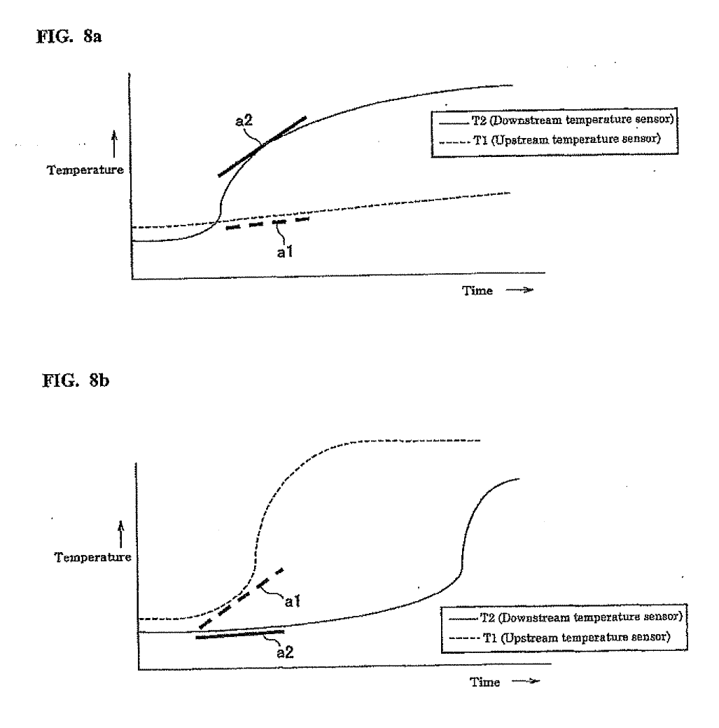

With respect to typical catalytic combustion and gas-phase combustion at the upstream side of the catalytic unit 21, gas temperature variations at the upstream and downstream sides of the catalytic unit 21 both immediately after the start of combustion and during continuous purge and intermittent purge are now described with reference to FIGS. 8a to 10.

Gas temperature changes at the upstream and downstream sides of the catalytic unit 21 immediately following the start of combustion will first be described with reference to FIGS. 8a and 8b. Depending on the system structure and control type, combustion starting processing is performed when the system is started. Namely, before the fuel cells 2 start to generate electricity, hydrogen and air are supplied to the combustion unit 9, and combustion processing is performed with respect to the catalytic unit 21. In addition, depending on the system type, a start purge process is performed in which anode off-gas is discharged from the anode for a predetermined time interval. However, since gas temperature variations at the upstream and downstream sides of the catalytic unit 21 are identical in these situations, the situation during typical starting is described below.

Immediately following the start of combustion, when the combustion state of the combustion unit 9 is in a typical catalytic combustion state, a reaction occurs at the catalytic unit 21 to thereby generate heat. Further, the heat generated in the catalytic unit 21 is transmitted to the downstream side of the catalytic unit 21 by gas flow such that the detected temperature T2 of the downstream temperature sensor 32 increases as shown in FIG. 8a to thereby exhibit a combustion temperature. Further, although the detected temperature T1 of the upstream temperature sensor 31 is increased by radiation heat from the catalytic unit 21, it is lower than the detected temperature T2 of the downstream temperature sensor 32 as shown in FIG. 8a. Also, the rate of increase a1 is slower (a1<a2).

When the upstream side of the catalytic unit 21 changes to a gas-phase state due to a back fire, combustion occurs between the cathode gas inlet 18 and the catalytic unit 21 (more specifically, between the mixer 20 and the catalytic unit 18). As shown in FIG. 8b, the detected temperature T1 of the upstream temperature sensor 31 is increased by the combustion heat to thereby exhibit combustion heat. Further, as shown once again in FIG. 8b, the detected temperature T2 of the downstream temperature sensor 32 is not directly affected by the heat generated from the gas-phase combustion such that the rate of increase is low, i.e., lower than the gas temperature T1 at the upstream side. If combustion is continued in this state, then the detected temperature T2 is increased, and a difference between the detected temperatures T1 and T2 is reduced.

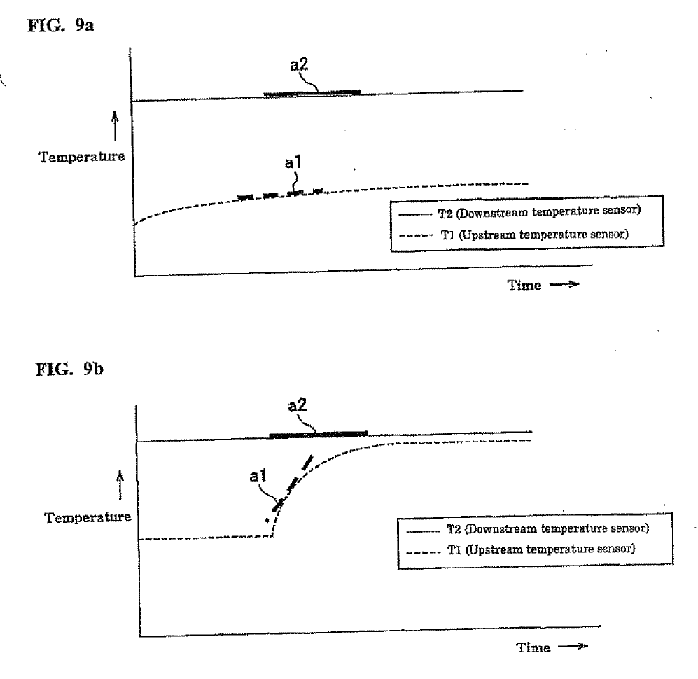

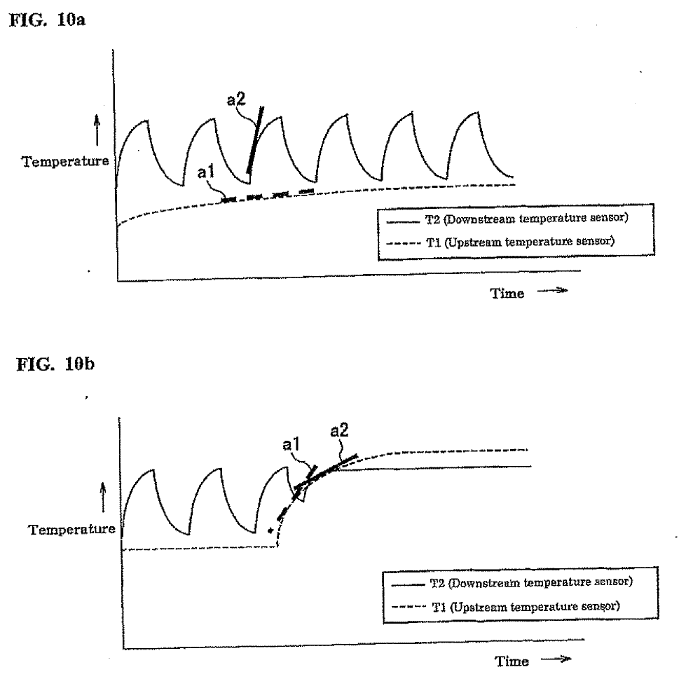

The following describes a gas temperature variation at the upstream and downstream sides of the catalytic unit 21 during a continuous purge and an intermittent purge with reference to FIGS. 9 and 10.

During the continuous or intermittent purge, reaction occurs in the catalytic unit 21 to generate heat when the combustion state of the combustion unit 9 is in a typical catalytic combustion state. Since the heat generated in the catalytic unit 21 is transmitted downstream of the catalytic unit 21 by the gas flow, the detected temperature T2 detected by the downstream temperature sensor 32 increases following startup, as shown in FIG. 8a. In accordance with the purge condition, the detected temperature T2 becomes a stable temperature (during the continuous purge; see FIG. 9a) or varies depending on fuel supply (during the intermittent purge; see FIG. 10a). Although the detected temperature T1 detected by the upstream temperature sensor 31 may rise due to the radiant heat transferred from the catalytic unit 21, it is generally lower than the detected temperature T2 detected by the downstream temperature sensor 32, as shown in FIG. 9a and FIG. 10a. In addition, the rate of temperature increase of the detected temperature T1 is slow compared to that of T2 (gradient of curves a1<a2). Meanwhile, when the upstream side of the catalytic unit 21 is in the gas-phase combustion state due to the back fire or the like, combustion occurs between the cathode gas inlet 18 and the catalytic unit 21 (i.e., between the mixer 20 and the catalytic unit 21), and, as shown in FIG. 9b and FIG. 10b, the detected temperature T1 detected by the upstream temperature sensor 31 rises due to the combustion heat.

As described above, during the typical catalytic combustion and the generation of the gas-phase combustion at the upstream side of the catalytic unit 21, since the gas temperature variation at the upstream and downstream sides of the catalytic unit 21 is deteriorated, the combustion state of the combustion unit 9 can be determined by monitoring this temperature variation. In addition, the table of FIG. 11 shows a relation between the temperatures T1 and T2 at the upstream and downstream sides of the catalytic unit 21 and the rates of temperature increase a1 and a2 thereof when the combustion unit 9 is in the typical catalytic combustion state and the upstream side of the catalytic unit 21 is in the gas-phase combustion state.

The following describes the operation of the controller 33 during a combustion state determining process according to exemplary embodiments of the invention. Such process uses the gas temperature variation property at the upstream and downstream sides of the catalytic unit 21 during the typical catalytic combustion and the gas-phase combustion occurring at the upstream side of the catalytic unit 21.

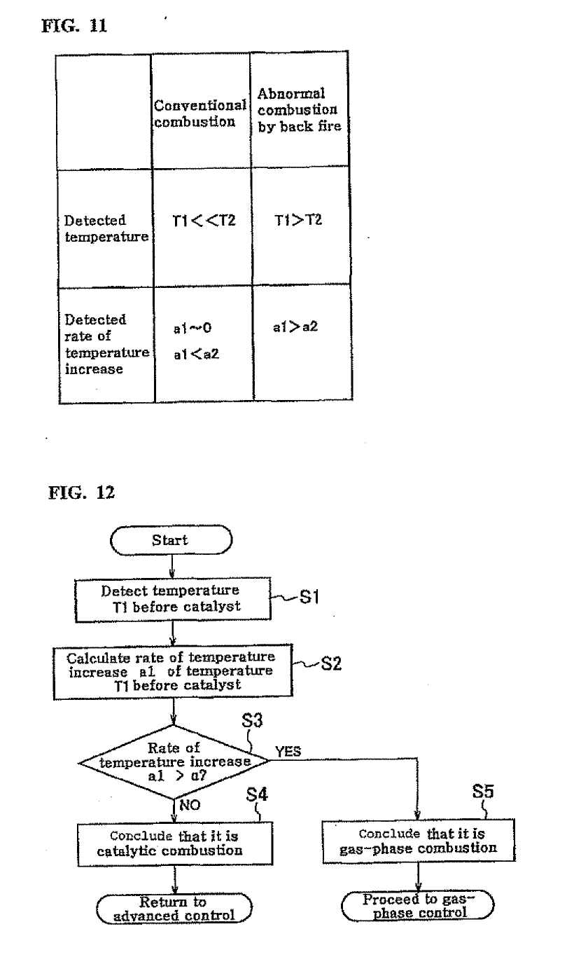

The operation of the controller 33 during the combustion state determining process according to a first embodiment of the invention is described with reference to the flowchart of FIG. 12.

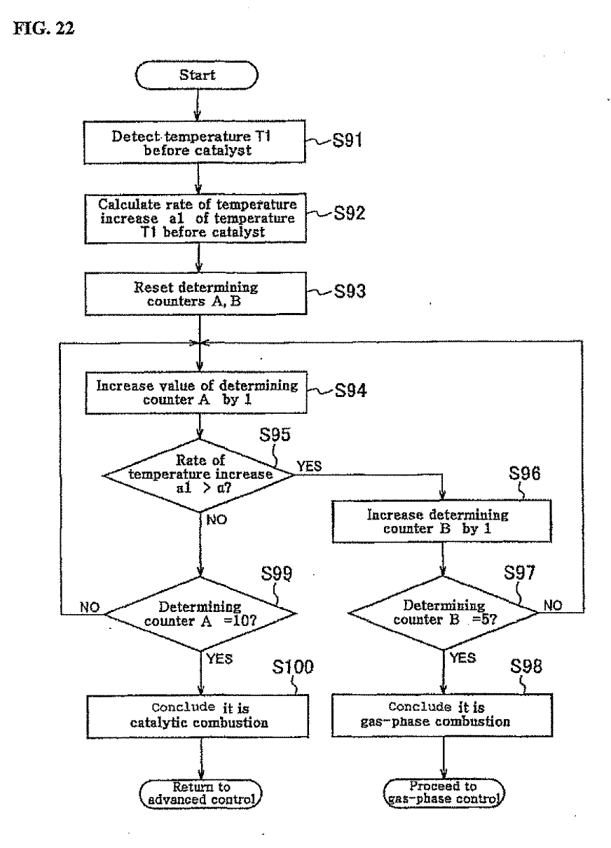

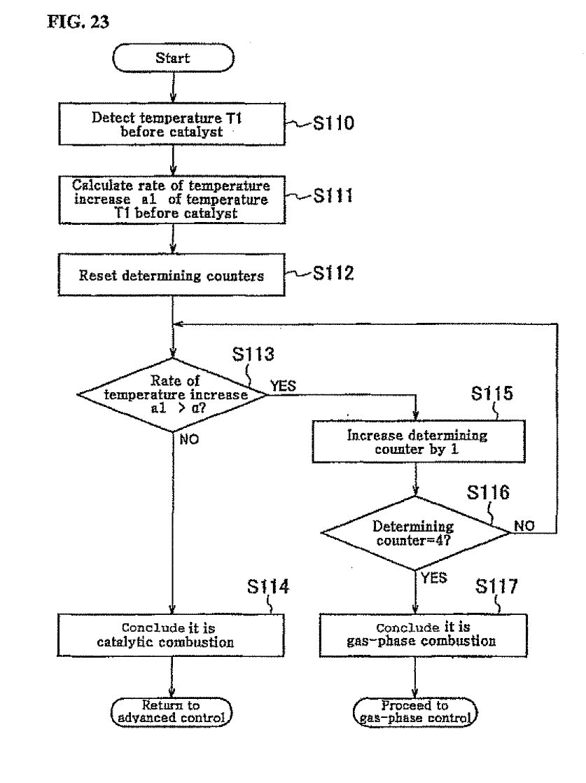

The flowchart of FIG. 12 illustrates a combustion state determining process that is performed after an advanced control process is performed when the fuel cell system 1 starts operating. The combustion state determining process starts from step S1. (Step S1 is equivalent to steps S91 and S110 in FIGS. 22 and 23, respectively). In addition, the combustion state determining process may be repeatedly performed at each predetermined sampling interval (t) ranging from 100 msec to 1 sec until the fuel cell system stops after it starts operating. At this point, when the sampling interval (t) is too short, it may be easily affected by noise. Thus, a measure for countering such a noise is required. When the sampling interval is too long, the determination of the gas-phase combustion at the upstream side of the catalytic unit 21 becomes retarded. Therefore, the sampling interval (t) may be properly set as needed according to the operational properties of the system. In addition, this combustion state determining process is performed at the predetermined sampling interval (t) independent from the advanced control process, and the input to a diagnosis flag representing the combustion state may be repeated. In such a case, the controller 33 performs the advanced control process with reference to the diagnosis flag.

In step S1 the controller 33 detects the gas temperature T1 of the upstream side of the catalytic unit 21 using the temperature sensor 31. As a result, step S1 is completed, and the determining process advances to step S2.

In step S2 the controller 33 calculates a difference between the previous gas temperature T1 and current gas temperature T1, which are both detected by step S1. The controller 33 divides the calculated difference by the sampling interval (t), thereby calculating the rate of temperature increase a1 (=dTi/dt). By doing so, step S2 is completed, and the determining process advances to step S3. (Step S2 is equivalent to steps S92 and S111 in FIGS. 22 and 23, respectively).

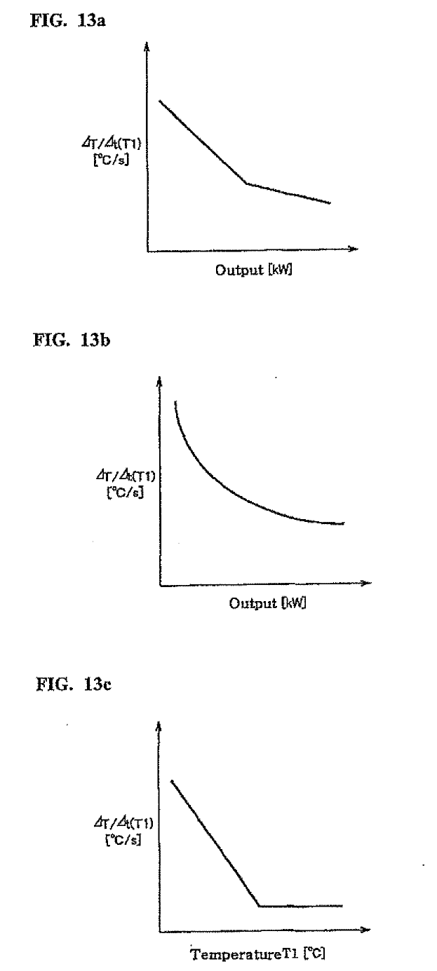

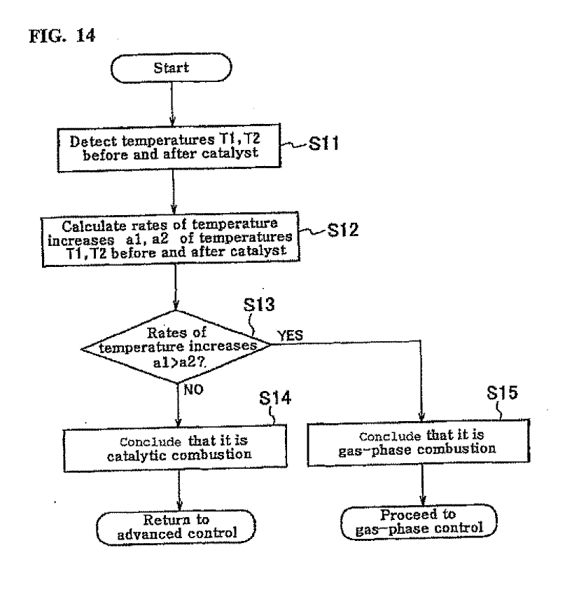

In step S3 the controller 33 determines if the rate of temperature increase a1 calculated in step S3 is greater than a determining reference value α. The determining reference value α may be one of a fixed value (e.g., 25° C./sec), a value that varies according to an operational load (output) of the system as shown in FIGS. 13a and 13b, and a value that varies according to the gas temperature T1 as shown in FIG. 13c, or may be set in accordance with the operational properties of the system or as determined by a designer. (Step S3 is equivalent to steps S95 and S113 of FIGS. 22 and 23, respectively). When it is determined that the rate of temperature increase a1 is greater than the determining reference value α [determining standard A1], the controller 33 allows the determining process to advance to step S5. Meanwhile, when it is determined that the rate of temperature increase a1 is less than or equal to the determining reference value α, the controller 33 allows the determining process to advance to step S4.

In step S4 the controller 33 concludes that the combustion unit 9 is in the typical catalytic combustion state and transmits a signal representing the typical catalytic combustion state to the advanced control to return the current control to the advanced control. Alternately, the controller 33 may return the current control step S1 rather than to the advanced control.

In step S5 the controller 33 concludes that the rate of temperature increase a1 of the temperature T1 is faster than the allowable rate of temperature increase, which is calculated with reference to the operational condition of the system. It further concludes that the gas-phase combustion is occurring at the upstream side of the catalytic unit 21. Subsequently, the controller 33 performs a gas-phase process control for suppressing the gas-phase combustion state. Alternately the controller 33 does not directly perform the gas-phase process control, but instead transmits a signal representing the occurrence of the gas-phase combustion state to the advanced control or establishes a gas-phase determining flag.

As clearly described above, according to the combustion determining process of the first embodiment, since the controller 33 determines the combustion state of the combustion unit 9 by using the rate of temperature increase a1 of the gas temperature T1 at the upstream side of the catalytic unit 21, it is possible to accurately and quickly determine that the gas-phase combustion occurs at the upstream side of the catalytic unit 21.

In accordance with the combustion state determining process according to the first embodiment, since the controller 33 determines that the upstream side of the catalytic unit 21 is in the gas-phase combustion state when the rate of temperature increase a1 is greater than the determining reference value α [determining standard A1], the combustion state of the combustion unit 9 can be determined before the temperature increases to a high level by the gas-phase combustion.

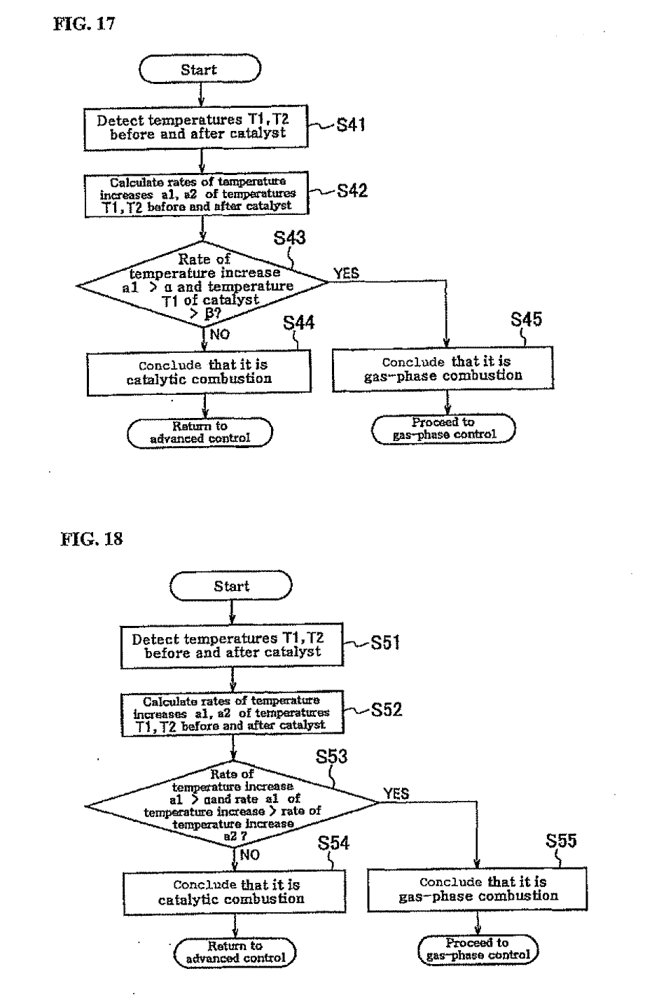

Further, when the determining standard A1 is satisfied and the gas temperature T1 at the upstream side of the catalytic unit 21 is greater than the allowable temperature that is determined in accordance with the operational condition [determining standard B1], the controller 33 may determine that the upstream side of the catalytic unit 21 is in the gas-phase combustion state. Therefore, diagnostic error due to the measured noise or the like can be prevented. Further, at the same time, the combustion state determining time can be shortened since a determining threshold value can be further lowered compared to a case where the determining is performed simply by using the temperature. In addition, as shown in the flowchart of FIG. 17, the process of step S3 may be changed into a process of step S43 for determining if the rate of temperature increase a1 is greater than the determining reference value α and if the gas temperature T1 is higher than a determining reference value β. In addition, for example, even when it takes about 10 seconds to detect the gas temperature T1 of 800° C., according to this process, it takes about 5 seconds to determine the gas-phase combustion state in the case where the determining threshold values of the rate of temperature increase a1 and the gas temperature T1 are respectively greater than 25° C./sec and 200° C. In addition, the combustion state control process can be performed even when the temperature of the combustion unit 9 is sufficiently low.

The operation of the controller 33 during the combustion state determining process according to a second embodiment is now described with reference to the flowchart of FIG. 14.

The flowchart of FIG. 14 illustrates a combustion state determining process that is performed after an advanced control process is performed when the fuel cell system 1 starts operating. The combustion state determining process starts from step S11.

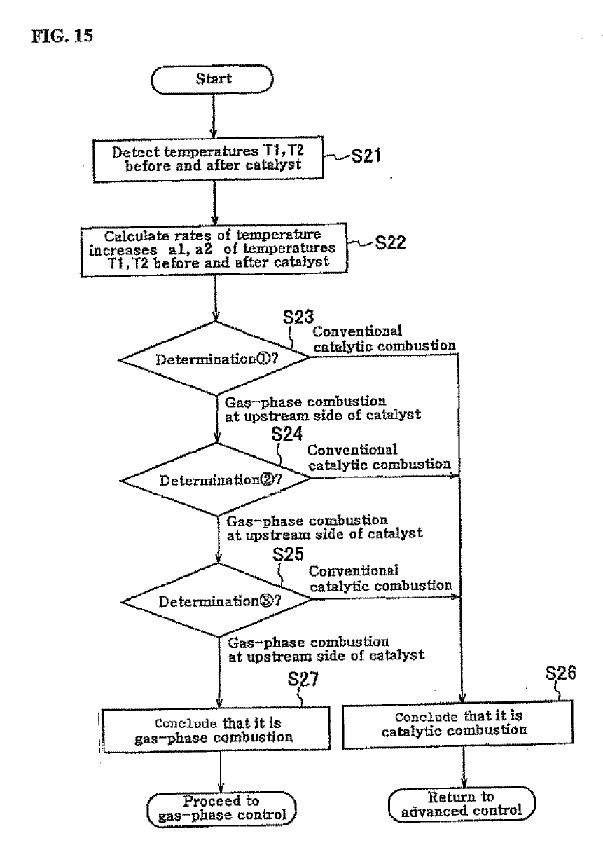

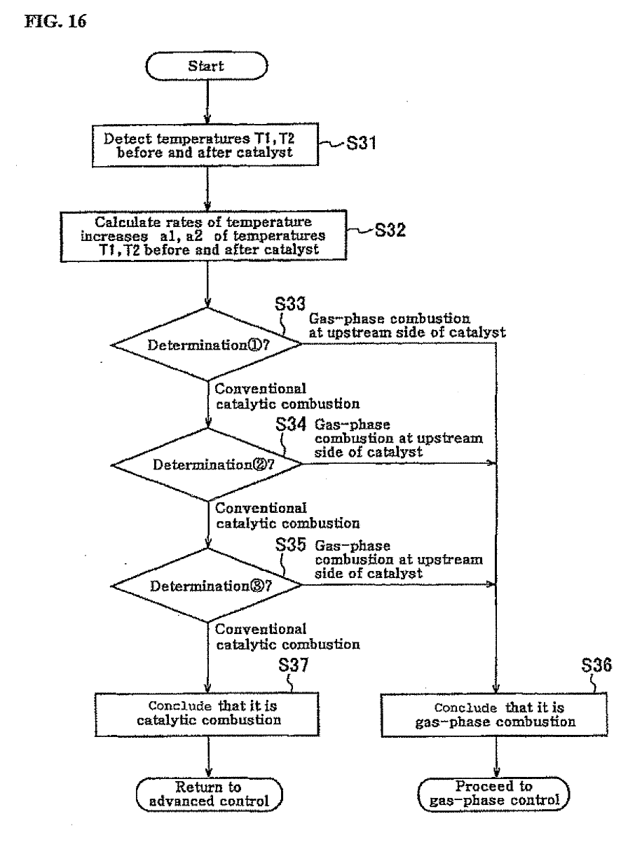

In step S11 the controller 33 detects the gas temperatures T1 and T2 at the upstream and downstream sides of the catalytic unit 21 by using the temperature sensors 31 and 32. As a result, step S11 is completed, and the determining process advances to step S12. (Step S11 is equivalent to steps S21, S31, S41, S51, S61, S71 and S81 of FIGS. 15-21 respectively).

In step S12 the controller 33 calculates a difference between the previous gas temperatures T1 and T2 and the present gas temperatures T1 and T2, which are detected by step S1. The controller 33 divides the calculated difference by the sampling interval (t), thereby calculating the rate of temperature increases a1 and a2 (=dT2/dt). Hence, step S12 is completed, and the determining process advances to step S13.

In step S13 the controller 33 determines if the rate of temperature increase a1 calculated in step S12 is greater than the rate of temperature increase a2. (Step S12 is equivalent to steps S22, S32, S42, S52, S62, S72 and S82 of FIGS. 15-21, respectively). When it is determined that the rate of temperature increase a1 is greater than the rate of temperature increase a2 [determining standard A2], the controller 33 concludes that the upstream side of the catalytic unit 21 is in the gas-phase combustion state at step S15 and performs the gas-phase process control. (Step S15 is equivalent to steps S27, S36, S45, S55, S65, S75, S85, S98 and S117 of FIGS. 15-23, respectively). Meanwhile, in step S14 when it is determined that the rate of temperature increase a1 is less than or equal to the rate of temperature increase a2, the controller 33 concludes that the combustion unit 9 is in the typical catalytic combustion state to return the current control to the advanced control. (Step S14 is equivalent to steps S26, S37, S44, S54, S64, S74, S84, S100 and S114 of FIGS. 15-23, respectively).

Alternately, the controller 33 may return the determining process to step S11 rather than to the advanced control. In addition, in step S13, the controller 33 may determine if the rate of temperature increase a1 is greater than a value that is obtained by adding a predetermined value γ to the rate of temperature increase a2. In this case, as with the determining reference value α, the predetermined value γ may be a value that varies in accordance with the operational condition.

As clearly described above, according to the combustion determining process of the second embodiment, since the controller 33 determines the gas-phase combustion state at the upstream side of the catalytic unit 21 by comparing at least one of the gas temperature and the rate of temperature increase at the upstream side of the catalytic unit 21 with at least one of the gas temperature and the rate of temperature increase at the downstream side of the catalytic unit 21, the combustion state determining time can be reduced. Further, at the same time, the determining error due to noise can be prevented. Also, the components of the downstream side of the catalytic unit 21 can be protected from heat damage due to the excessive increase in temperature.

According to the combustion state determining process of the second embodiment, since the controller 33 determines that the upstream side of the catalytic unit 21 is in the gas-phase combustion state when the rate of temperature increase a1 is greater than the rate of temperature increase a2 [determining standard A2], the gas-phase combustion state at the upstream side of the catalytic unit 21 can be determined before the temperature increases to a high level by the gas-phase combustion.

Further, when the rate of temperature increase a1 is greater than the determining reference value α [determining standard A1], and the rate of temperature increase a1 is greater than the rate of temperature increase a2 [determining standard A2], the controller 33 may conclude that the upstream side of the catalytic unit 21 is in the gas-phase state. Therefore, diagnostic error due to the measured noise or the like can be prevented. In addition, as shown in the flowchart of FIG. 18, this process can be performed by changing step S13 of FIG. 14 into a step S53 determining if the rate of temperature increase a1 is greater than the determining reference value α and if the rate of temperature increase a1 is greater than the rate of temperature increase a2.

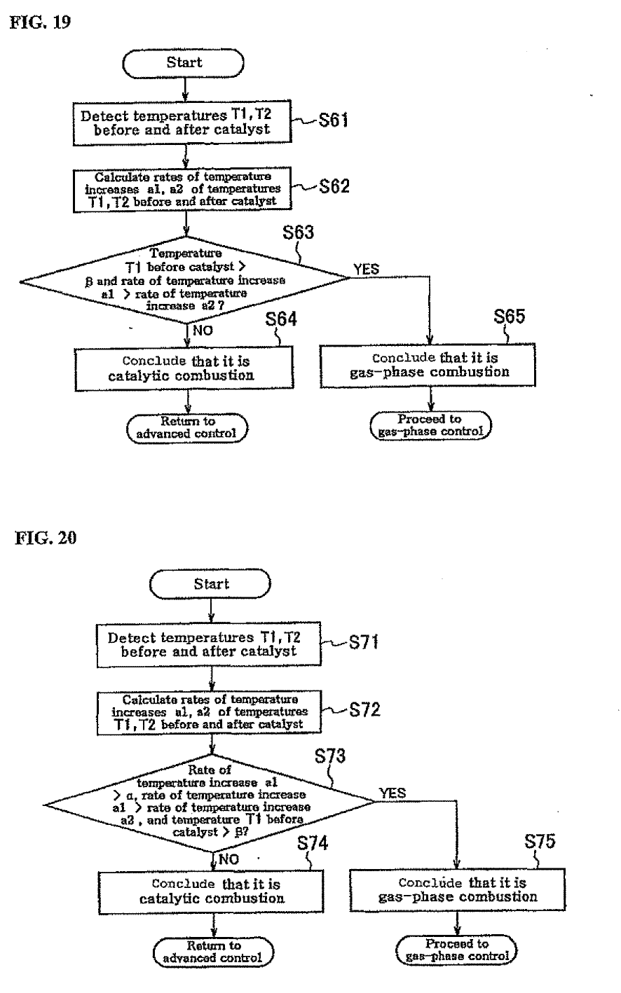

In addition, when the gas temperature T1 at the upstream side of the catalytic unit 21 is higher than the allowable temperature that is determined in accordance with the operational condition [determining standard B1] and the rate of temperature increase a1 is greater than the rate of temperature increase a2 [determining standard A2], the controller 33 may conclude that the upstream side of the catalytic unit 21 is in the gas-phase state. Hence, diagnostic error due to the measured noise or the like can be prevented. Further, at the same time, the combustion state determining time can be shortened since the determining threshold value can be further lowered compared to the case where the determining is performed simply by using the temperature. Furthermore, as shown in the flowchart of FIG. 19, this process may be performed by changing step S13 of FIG. 14 into a step S63 determining if the gas temperature T1 at the upstream side of the catalytic unit 21 is greater than the allowable temperature β that is determined in accordance with the operational condition, and if the rate of temperature increase a1 is greater than the rate of temperature increase a2.

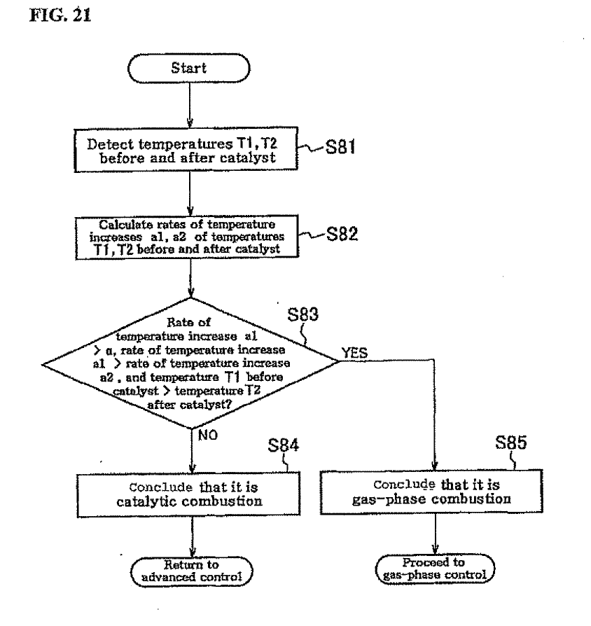

Further, the controller 33 may conclude that the upstream side of the catalytic unit 21 is in the gas-phase state when the rate of temperature increase a1 is greater than the determining reference value α [determining standard A1], the rate of temperature increase a1 is greater than the rate of temperature increase a2 [determining standard A2], and the gas temperature T1 at the upstream side of the catalytic unit 21 is higher than the allowable temperature β that is determined in accordance with the operational condition [determining standard B1]. By doing this, diagnostic error due to the measured noise can be prevented. Furthermore, as shown in the flowchart of FIG. 20, this process may be performed by changing step S13 of FIG. 14 into a step S73 determining if the rate of temperature increase a1 is greater than the determining reference value α, if the rate of temperature increase a1 is greater than the rate of temperature increase a2, and if the gas temperature T1 at the upstream side of the catalytic unit 21 is greater than an allowable temperature β that is determined in accordance with the operational condition.

In addition, the controller 33 may determine that the upstream side of the catalytic unit 21 is in the gas-phase state when the rate of temperature increase a1 is greater than the determining reference value α [determining standard A1], and/or the rate of temperature increase a1 is greater than the rate of temperature increase a2 [determining standard A2], and the gas temperature T1 at the upstream side of the catalytic unit 21 is higher than the gas temperature T2 at the downstream side of the catalytic unit 21 [determining standard B2]. By doing this, diagnostic error due to the measured noise can be prevented.

Furthermore, as shown in step S83 of the flowchart of FIG. 21, this process may be performed by changing step S13 of FIG. 14 into a step for determining if the rate of temperature increase a1 is greater than the determining reference value α, and/or if the rate of temperature increase a1 is greater than the rate of temperature increase a2, and if the gas temperature T1 at the upstream side of the catalytic unit 21 is greater than the gas temperature T2 at the downstream side of the catalytic unit 21. In addition, in step S83, the controller 33 may determine if the gas temperature T1 is greater than a value that is obtained by adding a predetermined value δ to the gas temperature T2. In this case, similar to the determining reference value α, the predetermined value δ may be a value that varies in accordance with the operational condition as shown in step S73.

The operation of the controller 33 during the combustion state determining process according to a third embodiment is now described with reference to the flowchart of FIG. 15.

The flowchart of FIG. 15 illustrates a combustion state determining process that is performed after an advanced control process is performed when the fuel cell system 1 starts operating. The combustion state determining process starts from step S21.

In step S21 the controller 33 detects the gas temperatures T1 and T2 at the upstream and downstream sides of the catalytic unit 21 by using the temperature sensors 31 and 32. By doing this, step S21 is completed, and the determining process advances to step S22.

In step S22 the controller 33 calculates a difference between the previous gas temperatures T1 and T2 and the current gas temperatures T1 and T2, which are detected in step S21. The controller 33 divides the calculated difference by the sampling interval (t), thereby calculating the rate of temperature increases a1 and a2 of gas temperatures T1 and T2. By doing this, step S22 is completed, and the determining process advances to step S23.

In step S23 the controller 33 determines if the combustion unit 9 is in a typical catalytic combustion state or in a gas-phase state of the upstream side of the catalytic unit 21 according to a first determining reference. The first determining reference may be a combination of at least two of the determining references A1, A2, B1 and B2 as needed by the designer. When it is determined in step S23 that the combustion unit 9 is in the typical catalytic state, the controller 33 allows the determining process to advance to step S27. Meanwhile, when it is determined that the upstream side of the catalytic unit 21 is in the gas-phase state, the controller 33 allows the determining process to advance to step S24.

In step S24 the controller 33 determines if the combustion unit 9 is in a typical catalytic combustion state or in a gas-phase state of the upstream side of the catalytic unit 21 according to a second determining standard. The second determining standard may be a combination of at least two of the determining standards A1, A2, B1 and B2 except for the combination of the first determining standard. When it is determined in step S24 that the combustion unit 9 is in the typical catalytic state, the controller 33 allows the determining process to advance to step S27. Meanwhile, when it is determined that the upstream side of the catalytic unit 21 is in the gas-phase state, the controller 33 allows the determining process to advance to step S25.

In step S25 the controller 33 determines if the combustion unit 9 is in a typical catalytic combustion state or in a gas-phase state of the upstream side of the catalytic unit 21 according to a third determining standard. The third determining standard may be a combination of at least two of the determining standards A1, A2, B1 and B2 except for the combinations of the first and second determining standards. When it is determined in step S25 that the combustion unit 9 is in the typical catalytic state, the controller 33 allows the determining process to advance to step S26. In step S26 the controller 33 concludes that the combustion unit 9 is in the typical catalytic combustion state to return the current control to the advanced control. Meanwhile, when it is determined that the upstream side of the catalytic unit 21 is in the gas-phase state, the controller 33 allows the determining process to advance to step S27. In step S27 the controller 33 concludes that the upstream side of the catalytic unit 21 is in the gas-phase combustion state and performs the gas-phase process control.

As clearly described above, according to the combustion determining process of the third embodiment, since the controller 33 determines the gas-phase combustion state at the upstream side of the catalytic unit 21 by using a combination of at least two of the determining standards A1, A2, B1 and B2, the diagnostic error is small and the determining standard having a short diagnosis time can be set.

In addition, when it is concluded that the upstream side of the catalytic unit 21 is in the gas-phase state, the controller 33 allows the determining process to proceed to a next determining step. However, as shown in FIG. 16, when it is determined that the combustion unit 9 is in a typical catalytic combustion state, the determining process may proceed to the next determining step (according to steps S33, S34 and S35). Furthermore, although the controller 33 determines the catalytic combustion state of the combustion unit 9 by using the three determining steps S23, S24, S25 in FIG. 15 (and steps S33, S34, S35 in FIG. 16), the number of determining steps may be 2, 4 or more. Furthermore, as the number of determining steps increases, the gas-phase state of the upstream side of the catalytic unit 21 can be accurately determined. However, when the number of determining steps is excessive, the time for determining the gas-phase combustion state increases. Therefore, the designer may properly adjust the number of determining steps while considering the system characteristics.

Exemplary embodiments of the invention are shown and described. The invention, however, should not be construed as being limited to the embodiments and drawings set forth herein. For example, in the foregoing embodiments, although it is determined through a single determining process if the upstream side of the catalytic unit 21 is in the gas-phase state, it may be possible that the processes of the flowchart of FIG. 12 are replaced with the processes of flowcharts of FIGS. 22 and 23. Further, it is determined that the upstream side of the catalytic unit 21 is in the gas-phase state after the combustion state determining process is performed several times. In particular, when the heat-damage determining process is performed at an interval of 0.1 sec, it can be determined that the upstream side of the catalytic unit 21 is in the gas-phase state in case it is determined that the gas-phase combustion occurs five times per 1 sec (10 cycles) (processes of steps S93, S94, S96, S97 and S99 of FIG. 22). Alternatively, it can be determined that the gas-phase combustions occur consecutively for 4 cycles (for 0.4 seconds) in 0.1 sec cycle (processes of steps S112, S115, and S116 of FIG. 23). According to this process, diagnostic error due to the influence of the noise can be prevented.

Also, the above-described embodiments have been described in order to allow easy understanding of the present invention and to not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. An apparatus for determining a combustion state of a catalytic combustion unit, comprising:
a fuel cell;
a catalytic combustion unit including a catalytic unit; and wherein the catalytic combustion unit is configured to mix an anode off-gas discharged from a fuel pole of the fuel cell and an oxidizing agent gas different from a cathode off-gas discharged from an oxidizing agent pole of the fuel cell and configured to perform combustion processing in the catalytic unit;
an upstream temperature detecting unit for detecting a gas temperature at an upstream side of the catalytic unit; and
a controller configured to compare at least one of the gas temperature at the upstream side of the catalytic unit and a rate of upstream temperature increase with a reference value to determine if gas-phase combustion occurs at the upstream side of the catalytic unit.

2. The apparatus according to claim 1, further comprising:
a downstream temperature detecting unit for detecting a gas temperature at a downstream side of the catalytic unit; and wherein the controller is further configured to compare at least one of the gas temperature at the upstream side of the catalytic unit and the rate of upstream temperature increase with a corresponding one of the gas temperature at the downstream side of the catalytic unit and a rate of downstream temperature increase to determine if the gas-phase combustion occurs at the upstream side of the catalytic unit.

3. The apparatus according to claim 1 further comprising:
a branching unit disposed at an upstream side of the fuel cell for dividing and supplying the oxidizing agent gas supplied to the oxidizing agent pole of the fuel cell to the catalytic combustion unit.

4. The apparatus according to claim 1 wherein the oxidizing agent gas supplied to the catalytic combustion unit is supplied by an oxidizing agent supply unit different from an oxidizing agent supply unit for supplying oxidizing agent gas to the oxidizing agent pole of the fuel cell.

5. The apparatus according to claim 1 wherein the oxidizing agent gas supplied to the catalytic combustion unit is supplied after passing through a case covering the fuel cell.

6. The apparatus according to claim 1 wherein the catalytic combustion unit further comprises:
an oxidizing agent gas inlet for supplying the oxidizing agent gas;
a fuel supply unit disposed at a downstream side of the oxidizing agent gas inlet for supplying the anode off-gas; and
a mixer disposed at a downstream side of the fuel supply unit and mixing the oxidizing agent gas and the anode off-gas; and wherein the catalytic unit is disposed at a downstream side of the mixer for combusting a mixed gas, the upstream temperature detecting unit disposed at the upstream side of the catalytic unit.

7. The apparatus according to claim 1, further comprising:
an exhaust unit for mixing the cathode off-gas and a combustion exhaust gas discharged from the catalytic combustion unit, the exhaust unit configured to discharge a resulting mixture outwardly of the apparatus.

8. The apparatus according to claim 7, further comprising:
a reverse flow preventing valve for preventing a reverse flow of a gas, the reverse flow preventing valve disposed on at least one of a cathode off-gas pipe and a combustion exhaust gas pipe for supplying the cathode off-gas and the combustion exhaust gas, respectively.

9. The apparatus according to claim 7, further comprising:
a pressure reducing unit for reducing a pressure of the cathode off-gas in the vicinity of a combustion exhaust gas pipe, the pressure reducing unit disposed at the exhaust unit.

10. The apparatus according to claim 1 wherein the controller is further configured to determine that the upstream side of the catalytic unit is in a gas-phase combustion state when the rate of upstream temperature increase is greater than an allowable rate of temperature increase determined according to operational conditions to thereby satisfy a first determining standard.

11. The apparatus according to claim 1 wherein the controller is further configured to determine that the upstream side of the catalytic unit is in a gas-phase combustion state when the rate of upstream temperature increase is greater than an allowable rate of temperature increase determined according to operational conditions to thereby satisfy a first determining standard, and when the gas temperature at the upstream side of the catalytic unit is greater than an allowable temperature determined according to operational conditions to thereby satisfy a second determining standard.

12. The apparatus according to claim 1 wherein the controller is further configured to determine that the upstream side of the catalytic unit is in a gas-phase combustion state when a difference between the rate of upstream temperature increase and a rate of downstream temperature increase at a downstream side of the catalytic unit is greater than a rate of temperature increase difference determined according to operational conditions to thereby satisfy a third determining standard.

13. The apparatus according to claim 1 wherein the controller is further configured to determine that the upstream side of the catalytic unit is in a gas-phase combustion state when the rate of upstream temperature increase is greater than an allowable rate of temperature increase determined according to operational conditions to thereby satisfy a first determining standard, and when a difference between the rate of upstream temperature increase and a rate of downstream temperature increase at a downstream side of the catalytic unit is greater than a rate of temperature increase difference determined according to operational conditions to thereby satisfy a third determining standard.

14. The apparatus according to claim 1 wherein the controller is further configured to determine that the upstream side of the catalytic unit is in a gas-phase combustion state when the gas temperature at the upstream side of the catalytic unit is greater than an allowable temperature determined according to operational conditions to thereby satisfy a second determining standard, and when a difference between the rate of upstream temperature increase and a rate of downstream temperature increase at a downstream side of the catalytic unit is greater than a rate of temperature increase difference determined according to operational conditions to thereby satisfy a third determining standard.

15. The apparatus according to claim 1 wherein the controller is further configured to determine that the upstream side of the catalytic unit is in a gas-phase combustion state when the rate of upstream temperature increase is greater than an allowable rate of temperature increase determined according to operational conditions to thereby satisfy a first determining standard, when the gas temperature at the upstream side of the catalytic unit is greater than an allowable temperature determined according to operational conditions to thereby satisfy a second determining standard, and when a difference between the rate of upstream temperature increase and a rate of downstream temperature increase at a downstream side of the catalytic unit is greater than a rate of temperature increase difference determined according to operational conditions to thereby satisfy a third determining standard.

16. The apparatus according to claim 15 wherein the controller is further configured to determine that the upstream side of the catalytic unit is in a gas-phase combustion state when the determining standards are consecutively satisfied within a time determined according to operational conditions.

17. The apparatus according claim 15 wherein the controller is further configured to determine that the upstream side of the catalytic unit is in a gas-phase combustion state when a predetermined ratio of the determining standards are satisfied during a time determined according to operational conditions.

18. The apparatus according to claim 1 wherein the controller is further configured to determine that the upstream side of the catalytic unit is in a gas-phase combustion state when at least one of (a) the rate of upstream temperature increase is greater than an allowable rate of temperature increase determined according to operational conditions to thereby satisfy a first determining standard, and (b) a difference between the rate of upstream temperature increase and a rate of downstream temperature increase at a downstream side of the catalytic unit is greater than a rate of temperature increase difference determined according to operational conditions to thereby satisfy a third determining standard, and the gas temperature at the upstream side of the catalytic unit is higher than the gas temperature of the downstream side of the catalytic unit by an amount greater than a temperature difference determined according to operational conditions to thereby satisfy a fourth determining standard.

19. A method for determining a combustion state of a catalytic combustion unit including a catalytic unit, a fuel cell positioned upstream from the catalytic combustion unit, the method comprising:
mixing in the catalytic combustion unit an anode off-gas discharged from a fuel pole of the fuel cell and an oxidizing agent gas different from a cathode off-gas discharged from an oxidizing agent pole of the fuel cell;
performing a combustion process in the catalytic unit;
detecting a gas temperature at an upstream side of the catalytic unit; and
comparing at least one of the gas temperature at the upstream side of the catalytic unit and a rate of upstream temperature increase with a reference value for determining if gas phase combustion occurs at the upstream side of the catalytic unit.

20. The method of claim 19, further comprising:
supplying the oxidizing agent gas from an air supply apparatus, by passing a supply of air through a case surrounding a cell stack forming the fuel cell before mixing in the catalytic combustion unit.

21. The method of claim 20, further comprising:
supplying air amounts required by the fuel cell and the catalytic combustion unit with at least one other air supply apparatus; and
positioning the at least one other air supply apparatus in a flow path in between the fuel cell stack and the catalytic combustion unit.
